(19) United States
(12) Patent Application Publication
(10) Pub. No.: US 2008/0227446 A1
(43) Pub. Date: Sep. 18, 2008

(54) Portable handheld satellite phone conversion module

(76) Inventor: Roy Wubker, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/856,246

(22) Filed: Sep. 17, 2007

Related U.S. Application Data
(63) Continuation-in-part of application No. 11/454,585, filed on Jun. 16, 2006.

(51) Int. Cl. H04Q 7/20

(52) U.S. Cl. 455/427

(57) ABSTRACT

A mobile communication device for communication and data transfer utilizing a satellite phone system including a module which replaces or supplements the battery of a satellite phone handset and includes an embedded micro-processor, a camera, a GPS unit, a compass, a mass storage device, a display screen and communication ports. The module is designed to transmit data and images without the need for additional software or other peripheral devices. The module is designed to completely enclose a satellite phone therein thereby providing environmental protection for the satellite phone.

### RELATED APPLICATIONS

This application is a continuation in part of U.S. application Ser. No. 11/454,585, entitled “PORTABLE HANDHELD SATELLITE PHONE CONVERSION MODULE”, filed on Jun. 16, 2006, which is hereby incorporated by reference.

### FIELD OF THE INVENTION

The invention generally relates generally to a satellite communication system. In particular, the invention comprises an integrated yet removable module for and method of modifying a commercially available portable handheld satellite phone handset. The module is designed to provide connectivity between the satellite phone system and data recording devices with near real-time data transfer capability to users via a satellite phone system without the use of a general purpose computer, a personal digital assistant (PDA) or the like, while still permitting normal voice operation and handheld functionality. The module can also perform a number of functions without being connected to the satellite phone.

### BACKGROUND OF THE INVENTION

A satellite phone is a device that transmits and receives messages via earth orbiting satellites. These satellite phones use either satellites in geostationary orbit, such as the civilian system INMARSAT®, or non-geosynchronous Low Earth Orbit (LEO) satellites for communication. Two currently deployed commercial LEO satellite systems are IRIDIUM® and GLOBALSTAR®. LEO satellites orbit the earth at relatively low altitudes and fly complete orbits. The low altitudes decreases the power required to effectively transmit a signal between a particular satellite and a satellite phone user on or near the earth. This decreased power requirement associated with LEO satellite systems has, in part, resulted in commercially available portable handheld satellite phones. Both satellite systems provide global, or near-global, phone service coverage at all times.

When a call is made with a portable handheld satellite phone, the call signal is transmitted from the satellite phone handset to a designated satellite operating within a particular service provider's satellite communication system. The signal is then transmitted to a particular service provider's designated terrestrial ground station (also referred to as a gateway), or to one of many other satellites in the system until the signal can reach a particular system designated gateway or directly to another satellite phone depending on the system and service provider. The gateways are interconnected to public, private or government switched networks, from where the signal is delivered to a terrestrial or airborne phone on the network or sent back via the satellite system to another satellite phone. This system of communication is often commonly referred to as “SATCOM”.

Satellite phones use only orbiting satellites and are independent of terrestrial infrastructure such as cellular phone towers for communication. These satellite phones are often used in remote areas of the world, in areas where disasters have occurred and in the middle of the oceans of the world. These are normally areas where terrestrial infrastructure does not exist.

Furthermore, portable handheld satellite phones generally operate on battery power, so there is limited independence from terrestrial power grids or generators between battery charging intervals. Thus, one will have uninterrupted global communication even in the event of total devastation like that occurring during war, after natural disasters or terrorist events, and the like, when all other forms of communication could be disrupted for weeks or indefinitely. Satellite phones are ideally suited for maritime, aviation, government/military, emergency/humanitarian services, mining, forestry, petroleum, etc. applications.

Commercially available portable handheld satellite phones typically include a handset-specific data connection port or cable sold as optional, add-on equipment for connection to peripheral equipment. The peripheral equipment could be a computer, a PC-104, a personal digital assistant (PDA), a camera, or another externally connected processor that enables the satellite phone to function like a digital modem to transmit pictures and other data to the end user via the satellite system. However, the use of these peripheral devices requires the use of other equipment, such as cables, etc. to connect the peripheral equipment to the satellite phone. This can present a problem when the user is located in remote or dangerous areas. These areas are normally difficult to access by vehicle and therefore all the equipment must be carried by the user. This limits the user's range of mobility and may limit which pieces of equipment the user selects to carry.

Until now commercially available satellite phone handsets have been lacking advanced features, such as cameras, GPS capability, and fully integrated data ports. Customers have come to expect these features with terrestrial phones (e.g., cellular phones).

What has been heretofore lacking in the art is an integrated yet removable, conformal module capable of removably interfacing with a commercially available portable handheld satellite phone to provide a combined portable handheld device capable of GPS, multimedia features and near real-time direct data transfer via an existing satellite phone system without the need for connection to a general purpose computer, PDA, or other externally connected processor device and its associated operating system. In addition, the conformal module is in form of a case which completely encloses the handheld satellite phone thus protecting the phone from the harsh elements of the environment. The conformal module can also be utilized without the satellite phone. In this form it contains its own power supply, in the form of replaceable, rechargeable batteries, which can power sensors connected to the module. The data collected by these sensors are stored in the memory of the conformal module and can be transmitted to the desired destinations via the satellite phone at a later time. The replaceable, rechargeable batteries can also be used to recharge the primary battery of the satellite phone.

### DESCRIPTION OF THE PRIOR ART

One example of a portable, handheld PDA device with embedded commercial Global Positioning System (GPS) and Iridium SATCOM board called “Talon Lite” is used by the U.S. Government based on Commercial Off-The Shelf (COTS) IRIDIUM® satellite communication capability and developed originally for military “blue force” tracking. Unlike the instant invention which uses direct modem-to-modem connection for near real-time data transfer, the device of “Talon Lite” uses Short Burst Data (SBD) protocol for data transmission. That is, the data received via satellite from the “Talon Lite” is organized into a packet at one of the two terrestrial gateways supporting the Iridium® system and supplied to the Internet via e-mail having a maximum 1960 bytes per packet with a delivery latency of about 5 to 20 seconds per packet. This SBD protocol necessitates that data files larger than 1960 bytes be broken into packets no larger that the defined size before it is fed into the modem, tracked, sorted and reassembled by software installed on the end receiving side that must be connected to the Internet to receive the multiple e-mail packets. The “Talon Lite” does not currently send data packets larger than 1960 bytes per message in its embodiment as a “blue force” tracking device, however, if larger files like an image were attempted, the process of multiple packets, multiple e-mails and its associated latency effect on data transfer would ensue. “Talon Lite” is also a completely repackaged handheld unit comprised of selected internal parts from an original commercially available satellite phone instead of an integrated yet removable conversion module for commercially available portable handheld satellite phones.

### SUMMARY OF THE INVENTION

The instant invention is related to a system for data transfer using a satellite phone system. The system includes a portable handheld satellite phone in electronic communication with an integrated yet removable conformal embedded system module and power supply that maintains the handheld and normal voice communication functionality of the satellite phone. The instant invention eliminates the need for a general-purpose computer, a PDA, or other externally connected processor device to be connected to the satellite phone to collect, transmit or receive data. The instant invention utilizes an embedded system that uses micro controllers to permit direct sensor data output-to-modem connection for near real-time continuous data transfer of sensor data, GPS, images and other large files for as long as a SATCOM link is established with an end user receiving the data via a modem connected to a general-purpose computer, PDA, or other processor device, or another satellite phone using the module of the instant invention.

The embedded system module and power supply is mounted in a removably attached, environmentally protective shell or module which completely encloses the portable handheld satellite phone. This embedded system module enables the removably attached, environmentally protective shell to contain a plurality of sensors and other devices which can operate without the need for a separate operating system. The removably attached shell can function independently of the portable handheld satellite phone. For example it can be equipped with various sensors, such as video, audio, vibration sensors, digital scanners such as finger print scanners, laser range finders, voice recorders and health/vital signs sensors and placed along a road. The sensors will record events, such as vehicles passing by, and store the information in storage media connected to the embedded system module. This information can be transmitted to distant locations at a later time when the portable satellite phone is connected to the embedded module and shell. A plurality of modules without satellites phones and having sensors can be connected together to form a network. The connections are preferably wireless but wired connections are also possible. These modules can in turn be connected to a module including a satellite phone. Data from all of the modules can be transmitted via the network to the module with the phone. The data can then be transmitted via the phone to other locations.

Embedded systems are known in the art as a specialized computer systems which are dedicated to perform specific pre-defined tasks, unlike a general-purpose computer, PC-104 based processor, or the like, which uses operating system software and device drivers to accomplish multiple tasks from a central processing unit (CPU). Programs on embedded systems often run with limited hardware/software resources. A personal digital assistant (PDA) is a type of embedded system, but its original embodiment was as a personal organizer that usually includes a clock, date book, address book, task list, memo pad, and calculator. PDA's in recent years have become much more versatile in that now they sometimes simulate the user operating environment and capabilities of a personal computer. Accordingly, the PDA has become a sort of hybrid departure from the original definition of an embedded system offering too much unnecessary capability and embedded software than is required to operate the instant invention. Embedded systems, in their basic form, use micro controllers to directly interface with components such as a GPS receiver, digital camera, mass storage device, or the like. This allows the embedded system to be intentionally simplified in design to lower costs, lower power consumption (about 1/10 the current draw of vernacular PC-104 technology), and increased efficiency and reliability as compared to general-purpose computers accomplishing the same task, because an embedded system is specifically designed to accomplish only the limited specific tasks it is designed to do. These embedded systems are capable of operating devices attached to the embedded systems by device interfaces (e.g. RCA, USB, RS-232, transistor-transistor logic (TTL), wireless and the like). An example of an embedded system currently used is embodied in a device that sends digital images directly from a digital camera to a printer without the use of a general-purpose computer, PDA, or the like. Another example is a camera enabled cellular phone that can capture a digital image, store the image, and transfer the image using the cellular phone as a digital modem, all without the use of a general-purpose computer, PDA, or other externally connected processor device.

The instant invention also includes a hand crank electrical power generator in the removable conformal attachment module and shell. This hand crank generator can be used to recharge the batteries which supply power to the module and shell. It can also be used to supply power to the entire device in the event the power level of the batteries drops below an operating level or the batteries cannot be readily recharged. Other features of the instant invention include an integral digital compass and a LED light which functions like a flashlight, illuminator or flash for a camera.

Accordingly, it is an objective of the instant invention to provide an integrated yet removable conformal attachment module and environmentally protective shell constructed and arranged to supplement the primary battery in the portable handheld satellite phone and be capable of operating the satellite phone, collecting, organizing, storing, and supplying data between the data gathering device or devices and the portable handheld satellite phone without the use of a general-purpose computer, PDA, or other externally connected processor unit.

It is a yet further objective of the invention to provide a supplemental power supply which comprises conventional rechargeable batteries such as NiMH in the form of AA, AAA, etc. which are readily available.

It is still a further objective of the instant invention to provide a conformal compact module for a satellite phone which completely encloses the phone and protects it from the environment and other destructive forces. This module is operative without the phone to collect data which can later be transmitted via the phone to another location when connected to any modem that accepts “AT” command sets.

It is yet another objective of the instant invention to provide a module encased in a conformal compact housing constructed and arranged to be removably attached to the portable handheld satellite phone to minimize the impact on the handheld functionality of the satellite phone while maintaining normal voice communication operation.

It is still further the objective of the invention to provide a system wherein encryption of data being transmitted from the module of the instant invention through the portable handheld satellite phone is possible.

Yet another objective of the invention is to provide a system which may include a removable memory storage device that can send stored images and data, on user demand or automatically, from the module of the instant invention connected to a portable handheld satellite phone to another portable handheld satellite phone with a module of the instant invention installed, or to any general-purpose computer, PDA, or the like, connected to a modem, which may or may not be another satellite telephone.

It is still a further object of the invention to provide a module encased in a conformal compact housing constructed and arranged to be removably attached to the portable handheld satellite phone which includes a hand crank electrical power generator that can be used to recharge the batteries of the module or the satellite phone or to supply power to the phone and module for operation thereof.

It is still yet a further object of the invention to provide a module encased in a conformal compact housing constructed and arranged to be removably attached to the portable handheld satellite phone which includes a compass mounted thereon.

It is still yet a further object of the invention to provide a module encased in a conformal compact housing constructed and arranged to be removably attached to the portable handheld satellite phone which includes an integral LED light which functions as a flashlight, illuminator or camera flash.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of a commercially available portable handheld satellite phone;

FIG. 2 is an exploded view of the module of the instant invention ready to be attached to a typical portable handheld satellite phone;

FIG. 3 is a front perspective of the module of the instant invention attached to a typical commercially available portable handheld satellite phone;

FIG. 4 is a block diagram of the modified satellite phone in accordance with the teachings of the present instant invention;

FIG. 5 is a front perspective view of another embodiment of the invention with the module in its open position;

FIG. 6 is a front perspective view of the embodiment of FIG. 5 with the module in its closed position and the satellite phone antenna stowed away;

FIG. 7 is a front perspective view of another embodiment of the invention with the module in its completely closed position;

FIG. 8 is a front perspective view of the embodiment of FIG. 7 in its open position and

FIG. 9 is a front perspective view of the embodiment of FIG. 7 in its open position with the antenna attached to the phone.

### DETAILED DESCRIPTION OF THE INVENTION

Detailed embodiments of the instant invention are disclosed herein, however, it is to be understood that the disclosed embodiments are merely exemplary of the instant invention, which may be embodied in various forms. Therefore, specific functional and structural details disclosed herein are not to be interpreted as limiting, but merely as a basis for the claims and as a representation basis for teaching one skilled in the art to variously employ the present instant invention in virtually and appropriately detailed structure.

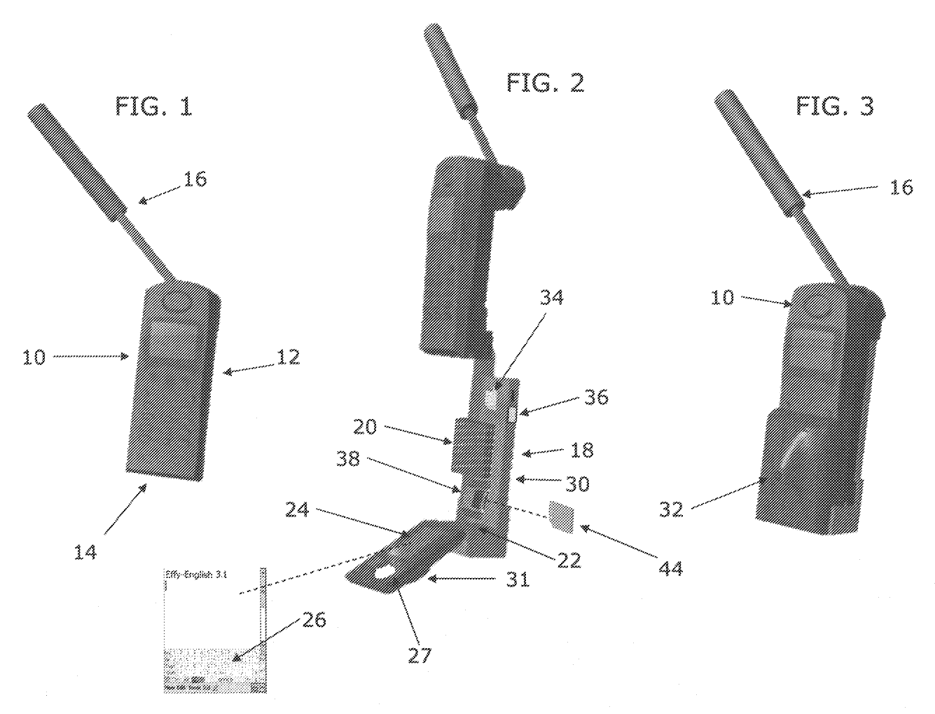

FIG. 1 illustrates a prior art commercial-off-the-shelf (COTS) Iridium® system Motorola® 9505 model portable handheld satellite phone 10 with its standard antenna 16 in the extended position. The handset 10 includes a removable battery 12 (not shown) and a handset specific data connection port 14. The data connection port provides an interface for a general-purpose computer, PDA, or the like, (not shown), to transmit and receive data using the satellite phone as a digital modem. It is noted that any other portable COTS satellite phones capable of providing voice and data communications to a satellite system could be used without departing from the scope of the instant invention.

As shown in FIG. 2 the module 18 of the instant invention is constructed and arranged to supplement the existing or primary battery 12 and the rear cover on the COTS portable handheld satellite phone with a plurality of higher capacity (mAh) batteries 62, preferably a rechargeable high density NiMH battery having at least 2500 mAh per 1.2 volt cell power reserve. The module of the instant invention is provided with connections 22 which are compatible with the data port connections 14 on the satellite phone. These connections 22 are used to transmit data, etc., from the module of the instant invention through the satellite phone connected to the satellite system. Data and other information received by the satellite phone are transmitted to the module of the instant invention via data port connection 14 and module connections 22.

The module of the instant invention is also provided with an embedded system consisting of micro controllers 31 that can be connected to external devices and in turn the embedded system communicates with the existing prior art portable handheld satellite phone. The connection for the external devices to the module of the instant invention is via port 36 utilizing digital bus standards such as Universal Serial Buss (USB), Serial connections, TTL or wireless connection. An example of a suitable microcontroller (MCU) that could be used in the module of the instant invention embedded system is an ATMEL® AT91RM9200.

The instant invention module may also include a unit 31 which may pivot from a stowed position proximate to the outer housing of the portable handheld satellite telephone as shown in FIG. 3, to a deployed position, as shown in FIG. 2. This unit includes a display screen 24, at least one user input (touch screen, keypad, keyboard, or the like) 26 and embedded digital camera 32. The camera can function to capture images or video for transmission elsewhere through the portable handheld satellite phone or storage on the module of the instant invention. One example of the display screen is a liquid crystal display (LCD) screen. Another non-limiting example of a display screen is a touch screen such as the COG-C128128 touch screen and the COG-T177MLH-01 touch controller from Varitronix®. In addition, the user could utilize a standardized virtual keyboard or keypad on the display screen and/or a 5-way push button unit. The user enters data, commands or reviews data via virtual buttons displayed on the screen and/or the 5-way push button unit.

The module of the instant invention when connected to a portable handheld satellite phone can also have external devices such as sensors (not shown) connected to it via its available data ports 36. These sensors can include but are not limited to seismic, chemical, radiation, acoustic, broadcast, magnetic, biological, other cameras including Night Vision (NV) and infra red (IR), etc., in addition to the embedded camera integral to the module of the instant invention. These sensors can be controlled through specific software residing on the module of the instant invention to monitor over a specific time interval or respond to a specific event by activating the portable handheld satellite telephone to make a data call automatically to a monitoring station. For example a specific radio frequency can be monitored to see if and when a transmission occurs. When a transmission is detected the satellite phone will transmit a message and/or contact a specific individual. In this manner, the portable handheld satellite phone and the module of the instant invention 18 attached can be placed in the field and left unattended in a low power consumption or sleep mode to collect data from sensors until a user specified time interval or sensor detection event occurs and initiates a power-up of the portable handheld satellite phone, module and records data or transmits a data call. Pictures can be taken from the embedded camera in the module of the instant invention to capture a sensor detection event and/or to act as a secondary control verification of the unit's position in addition to the embedded Global Positioning System (GPS) unit. A user monitoring the sensors connected to the module of the instant invention can change sensors settings, time intervals, hand-off to another user dial-up number, etc., remotely at any time via SATCOM while a data call is established. For example if a digital camera is connected to the phone as an external device, the user can access the memory of the digital camera through the embedded module of the satellite phone and download the images captured by the digital camera.

Another feature of the invention is the ability to program the phone to transmit data only after it has reached a specific location. For example, data can be acquired in one location and the transmission of the data will only occur after the phone has been relocated to another location by utilizing the GPS unit of the module. This may onboard a ship at a specific way point.

In addition to the sensors, these embedded systems are capable of operating any peripheral device which can be operated by input commands received from microprocessors. Examples of these are, but not limited to, control valves in fluid supply lines, electric motors, compressors, refrigeration units, surveillance equipment, transmitters, receivers, etc.

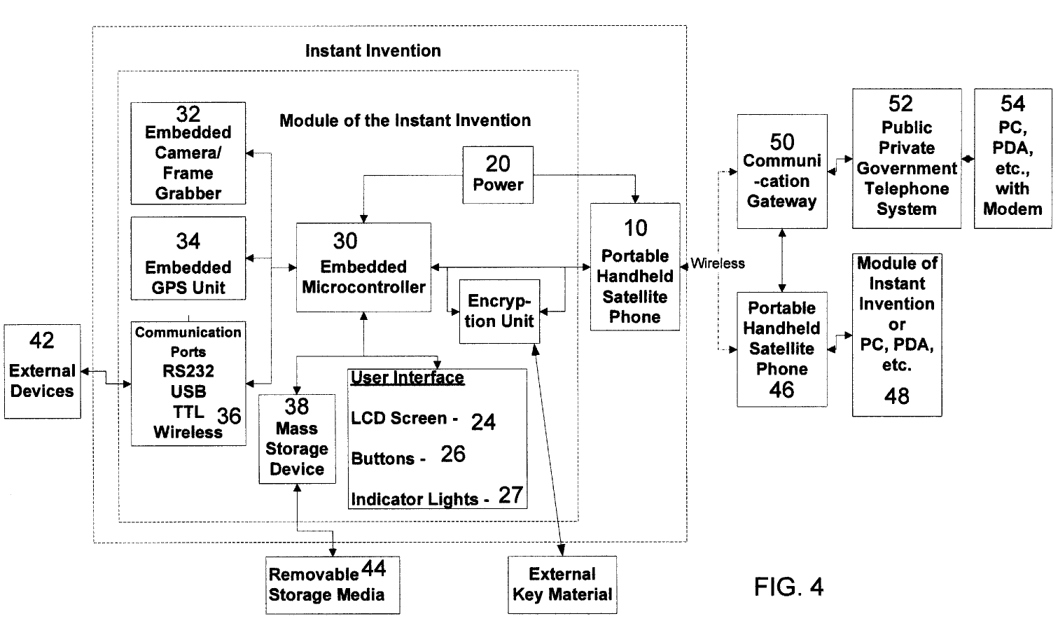

FIG. 4 is a block diagram showing the functional components housed inside the removable module of the instant invention and portable handheld satellite phone. The removable module of the instant invention includes an embedded micro controller (MCU) 30 that is connected to an embedded camera/frame grabber 32, an embedded GPS unit 34, communication ports 36, a mass storage device 38, and at least one user interface means 24, 26, 27. The mass storage device 38 is connected to the embedded microcontroller 30. This mass storage device 38 utilizes removable storage media 44 to store images from the embedded digital camera 32, GPS data from the embedded GPS unit 34, bearing information from the embedded compass or other data from sensors, other cameras, and the like, connected as external devices 42 on the removable storage media 44. Some non-limiting examples of removable storage media include memory cards such as Secure Digital (SD), Multi Media Card (MMC) and CompactFlash®. An embedded Global Position System (GPS) unit 34 can provide the microcontroller with the location of the portable handheld satellite phone in terms of longitude/latitude/altitude coordinates within the accuracy of the GPS system as well as date and time information. The mass storage device 38 can be programmed to store the information from the GPS unit 34 and data sent and received by the embedded microcontroller (MCU) 30 on the storage media 44. From stored GPS information or sent continuously near real-time via SATCOM, velocity of movement and mapping of position thereof of the instant invention can be performed by a user receiving the information via SATCOM connected to a general-purpose computer, PDA, or the like with appropriate software. The user interface can be used to access the information stored on the mass storage device 38 or it can be accessed remotely by another user via SATCOM. The user can also access information stored on external devices 42 such as sensors, other cameras, and the like, connected to the module of the instant invention from the user interface 40 or it can be accessed remotely by another user via SATCOM. In this way, a user accessing the unit remotely via SATCOM is able to “see through” the instant invention directly to the sensor device for near real-time reporting of data and which may also have its own integrated mass storage device. The embedded GPS unit 34 connected to the embedded microcontroller (MCU) 30 will receive signals from the GPS satellites and inform the embedded microcontroller as to the position of the instant invention and the current date/time.

The Iridium® system Motorola® 9505 portable handheld satellite phone and potentially its follow-on versions thereof is approved by the United States National Security Agency (NSA) for use as a secure communication device for transmission of U.S. Government classified information when coupled with a non-limiting specially designed communication security (COMSEC) module with necessary key material, U.S. Government secure subscriber identity module (SIM) card for access through the designated U.S. Government gateway, and a satellite phone handset seal. The instant invention designed to integrate with the Iridium® system, and potentially other applicable future NSA approved SATCOM systems, can incorporate the necessary COMSEC equipment to ensure secure transmission and receipt of data and voice communications of U.S. Government classified information in accordance with NSA guidelines and NSA approval.

The portable handheld satellite phone 10 of the instant invention is in wireless communication with other satellite phones 46, which in turn may be provided with the module of the instant invention or connected to a general-purpose computer, PDA, and the like. If communication is between at least two (2) instant inventions, data and images can be shared directly between the instant inventions in near real-time and displayed on each respective instant invention display screen without the use of a general-purpose computer, PDA, or the like. Also, the portable handheld satellite phone of the instant invention may be wirelessly connected to a communications gateway 50 which in turn is connected to a public, private or government telephone system 52. A general-purpose computer, PDA, or the like connected to a modem 54 may be connected to the public, private or government telephone system for communication with the instant invention.

A plurality of modules 18 without the satellite phones can be networked together utilizing wireless connections. This network can also include a module provided with a phone. The modules without the phones are provided with sensors to obtain data. The collected data is then transmitted to the module with the phone so that it can be transmitted to another location in real time or at another time. The modules can also be connected to any modem that accepts “AT” command sets. As a result the modules can transmit their collected data via cell phones, via conventional phones utilizing Laptop computer as a modem and via conventional phone lines provided with modems that accept “AT” command sets.

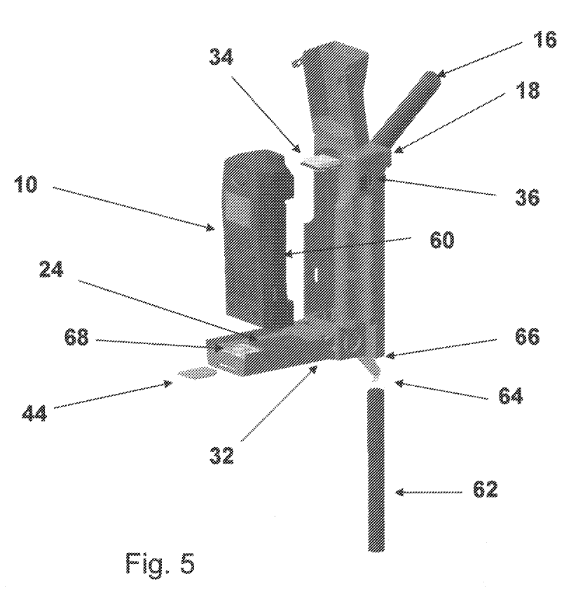

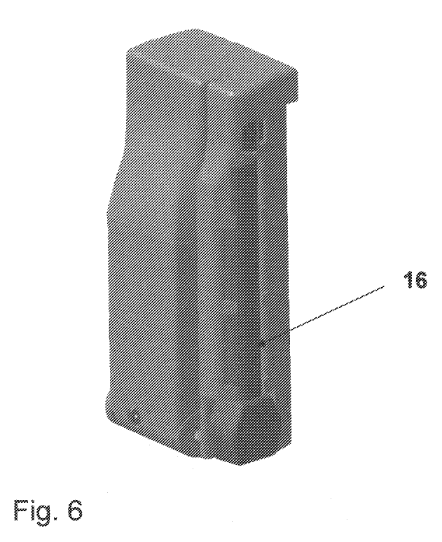

Another embodiment of the invention is illustrated in FIGS. 5 and 6. The satellite phone 10 is provided with the standard battery 60. This battery can be supplemented with commercially available batteries 62. These batteries are preferably AA NiMH batteries having 2500 mAh per 1.2 volt cell power reserve. Other types and sizes of batteries such as Lithium Ion, Alkaline, AAA, C and D can also be employed as long as they provide sufficient power to operate the satellite phone and/or module. These batteries can be of the rechargeable or non-rechargeable type. A hand crank 64 is attached to the lower portion of the module. The hand crank 64 can be utilized to recharge the batteries or to power the module in the event of complete loss of battery power. With the supplemental batteries 68 removed the hand crank will recharge the primary battery of the satellite phone. A LED light 66 is built into or secured to the lower portion of the module. The LED light functions as a flashlight, illuminator or can utilized as a beacon. The LED can also function as a flash for the camera. When it is utilized in this fashion it is mounted in the front of the lower, hinged portion 31 of the module.

The camera 32 is also incorporated into the lower, hinged portion 31 of the front of the module. An LCD display 24 is incorporated into this hinged portion of the module on the interior side thereof. A charge-transfer capacitive controller in the form of a wheel 68 is located on the interior side of the lower, hinged portion and is used to control the LCD display, control the module or enter data into the module. The wheel 68 is a charge-transfer capacitive controller available from Quantum Research Group. A removable storage media 44 is connected to the module through a port 70 located on the hinged portion. Peripheral sensors (not shown) are connected to the module through data ports 36. The sensors can also be connected to the module via the storage media port 70. The data from the sensors can also be wirelessly transmitted to the module. A GPS unit 34 is incorporated into an upper portion of the module. A digital compass 35 is also incorporated into the upper portion of the module. In addition to the sensors previously described, other sensors such as digital scanners, fingerprint scanners, eye scanners, voice recorders, laser range finders and health/vital signs scanners can also be connected to the module utilizing the previously described connections. Data from these scanners can be stored in the module if the satellite phone is not connected to the module and transmitted via the phone at a later time or connected to any modem that accepts “AT” command sets.

When the module is completely closed the antenna 16 is stored in the module adjacent the batteries as illustrated in FIG. 6.

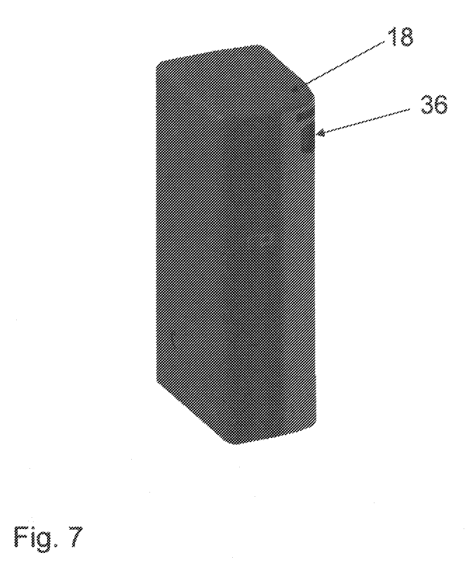

FIGS. 7-9 illustrate another embodiment of eth present invention. In this embodiment the module 18 completely encloses all of the components of the communication system. FIG. 7 illustrates the module 18 in its completely closed position. The only communication to the communication system therein is via the data ports 36.

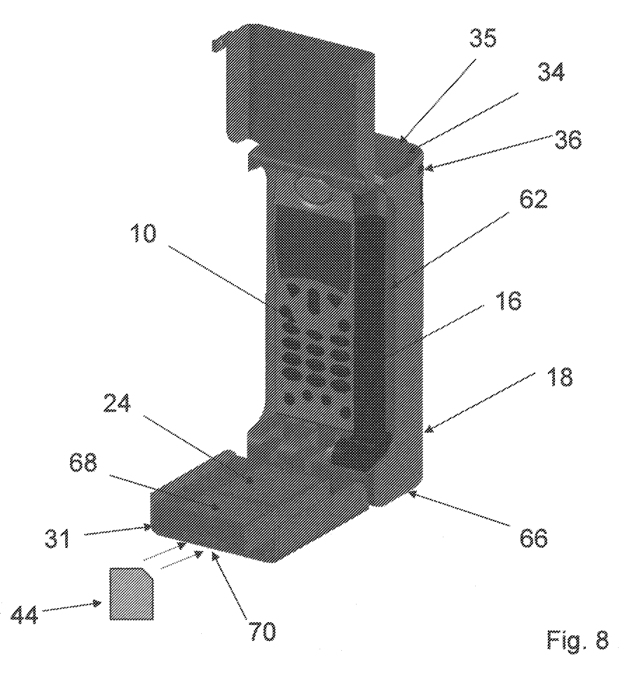

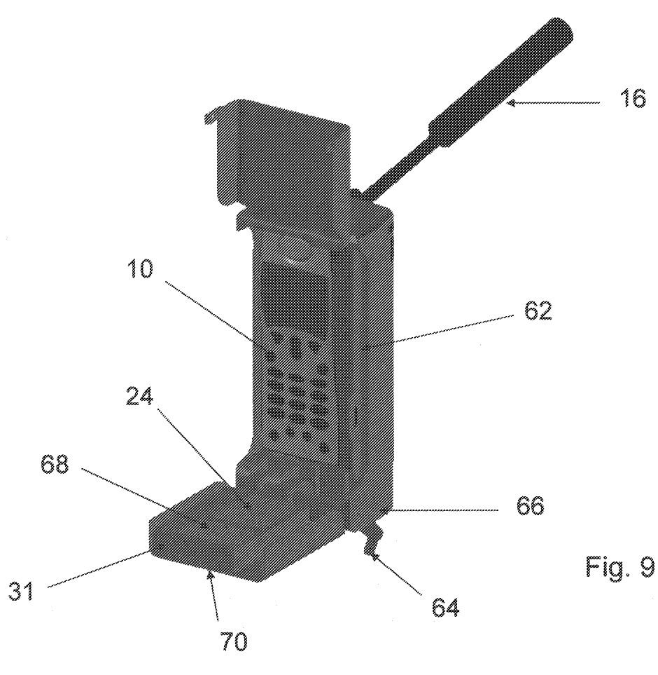

FIG. 8 illustrates this embodiment in its open position. Satellite phone 10 is enclosed within the module 18. The phone antenna 16 is secured adjacent the phone within the module. Supplemental batteries 62 and located adjacent the antenna. In this embodiment 6 supplemental batteries are employed. Hinged lower portion 31 is shown in its open position. LCD display screen 24 and charge-transfer capacitive controller wheel 68 are positioned on the interior of lower portion 31. A removable storage media 44 is connected to the module through a port 70 located on the hinged portion. Peripheral sensors (not shown) are connected to the module through data ports 36. The sensors can also be connected to the module via the storage media port 70. A GPS unit 34 and digital compass 35 are embedded in the upper portion of module 18. A LED light is located in the lower portion of the module. The LED light can also be positioned on the exterior of the hinged portion 31 to function as a flash for the camera. FIG. 9 illustrates a hand crank 64 which is used to provide power to the batteries.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures include herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which encompassed within the spirit of the invention and are defined by the scope of the appended claims. Although the invention has been described in connection with the preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A mobile communication device for communication and data transfer using a satellite telephone system, said device comprising:
a satellite communication phone, mounted in a portable housing of a size to be handheld by a person, including a primary battery;
a module constructed and arranged to supplement said primary battery of said satellite communication phone;
said module including at least one embedded controller, said embedded controller constructed and arranged to organize and streamline data acquired by at least one peripheral device for transfer to said phone whereby said phone transmits said data or voice communication wirelessly to another satellite communication phone;
said module including a supplemental power supply ion the form of batteries for supplying power to said module and said satellite communication phone;
said module completely enclosing said satellite communications phone.

2. The mobile communication device as set forth in claim 1, wherein said module is constructed and arranged as an integrated yet removable conformal attachment unit on said satellite communication phone;
said module being operational without said satellite communication phone.

3. The mobile communication device as set forth in claim 1, wherein said module includes a data port constructed and arranged for connection to a data port on said satellite communication phone enabling data transmission between said module and said satellite communication phone.

4. The mobile communication device as set forth in claim 1, wherein said module includes a hand crank electrical power generator constructed and arranged to supply electrical power to said mobile communications device and recharge said primary battery.

5. The mobile communication device as set forth in claim 1, wherein said module includes a hand crank electrical power generator constructed and arranged to supply electrical power to said mobile communications device and recharge said supplemental batteries.

6. The mobile communication device as set forth in claim 1, wherein said module includes an integral digital compass.

7. The mobile communication device as set forth in claim 1, wherein said module includes an integral Light Emitting Diode light for supplying light.

8. The mobile communication device as set forth in claim 1, wherein said peripheral devices include at least one external sensor, said sensor is selected from the group of a digital scanner, a fingerprint scanner, a digital voice recorder, a laser range finder or a health and vital signs scanner.

9. The mobile communication device as set forth in claim 1, further including at least one data access port on said module, said data access port comprising at least one port selected from the group of a serial port, a Universal Serial Bus (USB) port, a TTL port or a wireless port; said at least one external sensor connected to said communication device through said at least one data access port.

10. The mobile communication device as set forth in claim 1, wherein said module further includes a mass storage device with removable memory media for storing data acquired by said at least one peripheral device and other data.

11. The mobile communication device as set forth in claim 1, further including means for selectively activating said at least one peripheral device.

12. The mobile communication device as set forth in claim 1, further including means to place the communication device in a power down mode and means to reactivate said communication device when a sensor detects or measures a physical property or event or at a certain time interval.

13. An integrated yet removable module for a portable satellite phone including a data port, said module comprising:
at least one embedded controller, said embedded controller constructed and arranged to capture images, GPS and directional bearing data and organize and streamline data acquired by at least one peripheral device for transfer to a satellite phone;
at least one data access port for connection to said at least one peripheral device;
a plurality of batteries for supplying power to a portable satellite phone and said module;
means to transmit said data or voice communication wirelessly via a particular satellite system to another satellite phone and said module being constructed and arranged to completely enclose a portable satellite phone therein.

14. The removable module as set forth in claim 13, wherein said module includes a data port constructed and arranged for connection to a data port on a satellite communication phone enabling data transmission between said module and said satellite communication phone.

15. The removable module as set forth in claim 13, wherein said module includes a hand crank generator constructed and arranged to supply electrical to said mobile communications device and recharge said primary battery.

16. The removable module as set forth in claim 13, wherein said module includes a hand crank electrical power generator constructed and arranged to supply electrical power to said module and recharge said supplemental batteries.

17. The removable module as set forth in claim 13, wherein said module includes an integral digital compass.

18. The removable module as set forth in claim 13, wherein said module includes an integral Light Emitting Diode light for supplying light.

19. The removable module as set forth in claim 13, wherein said peripheral devices include at least one external sensor, said sensor is selected from the group of a digital scanner, a fingerprint scanner, a digital voice recorder, a laser range finder or a health and vital signs scanner.

20. The removable module as set forth in claim 13, further including at least one data access port on said module, said data access port comprising at least one port selected from the group of a serial port, a Universal Serial Bus (USB) port, a TTL port or a wireless port; said at least one external sensor connected to said module through said at least one data access port.

21. The removable module as set forth in claim 13, wherein said module further includes a mass storage device with removable memory media for storing data acquired by said at least one peripheral device and other data.

22. The removable module as set forth in claim 13, further including means for selectively activating said at least one peripheral device.

23. The removable module as set forth in claim 13, further including means to place said module in a power down mode and means to reactivate said module when a sensor detects or measures a physical property or event or at a certain time interval.

24. The removable module as set for the in claim 13, wherein said plurality of batteries comprise a single battery.
